(19) United States
(12) Patent Application Publication
(10) Pub. No.: US 2026/0155635 A1
(43) Pub. Date: Jun. 4, 2026

(54) ELECTRODE SHAPE FORMING METHOD AND ELECTRODE SHAPE FORMING DEVICE

(71) Applicant: SUBARU CORPORATION, Tokyo (JP)

(72) Inventor: Masaaki KATO, Tokyo (JP)

(21) Appl. No.: 19/377,589

(22) Filed: Nov. 3, 2025

(30) Foreign Application Priority Data
Dec. 4, 2024 (JP) 2024-211170

(51) Int. Cl. H01T 21/02; C23C 4/06; C23C 4/134

(52) U.S. Cl. CPC H01T 21/02; C23C 4/06; C23C 4/134

(57) ABSTRACT

An electrode shape forming method includes generating discharge between a central electrode and an outer electrode of an ignition plug of an engine in a state in which the engine is driven by an electric motor and metal powder is supplied to a combustion chamber of the engine. As a result of the generating the discharge between the central electrode and the outer electrode of the ignition plug, the metal powder is thermally sprayed to one or both of the central electrode and the outer electrode.

### CROSS-REFERENCE TO RELATED APPLICATIONS

The present application claims priority from Japanese Patent Application No. 2024-211170 filed on Dec. 4, 2024, the entire contents of which are hereby incorporated by reference.

### BACKGROUND

The disclosure relates to an electrode shape forming method and an electrode shape forming device.

An engine using a fuel, such as gasoline, includes an ignition plug provided with a central electrode and an outer electrode (see Japanese Unexamined Patent Application Publication (Translation of PCT Application) No. 2009-533802, Japanese U.S. Pat. No. 4,532,802, and Japanese Unexamined Patent Application Publication No. 2004-288376, for example).

### SUMMARY

An aspect of the disclosure provides an electrode shape forming method. The electrode shape forming method includes generating discharge between a central electrode and an outer electrode of an ignition plug of an engine in a state in which the engine is driven by an electric motor and metal powder is supplied to a combustion chamber of the engine. As a result of the generating the discharge between the central electrode and the outer electrode of the ignition plug, the metal powder is thermally sprayed to one or both of the central electrode and the outer electrode.

An aspect of the disclosure provides an electrode shape forming device including an electric motor, a powder supply unit, and a voltage application unit. The electric motor is coupled to an output shaft of an engine. The powder supply unit is attached to the engine and stores metal powder therein. The voltage application unit is coupled to an ignition plug of the engine and is configured to generate discharge between a central electrode and an outer electrode of the ignition plug. The voltage application unit is configured to thermally spray the metal powder to one or both of the central electrode and the outer electrode as a result of generating the discharge between the central electrode and the outer electrode in a state in which the engine is driven by the electric motor and the metal powder is supplied to a combustion chamber of the engine by the powder supply unit.

An aspect of the disclosure provides an electrode shape forming device including an electric motor, a powder supply unit, a voltage application unit, and circuitry. The electric motor is coupled to an output shaft of an engine. The powder supply unit is attached to the engine and stores metal powder therein. The voltage application unit is coupled to an ignition plug of the engine. The circuitry is configured to generate discharge between a central electrode and an outer electrode of the ignition plug. The circuitry is configured to thermally spray the metal powder to one or both of the central electrode and the outer electrode as a result of generating the discharge between the central electrode and the outer electrode in a state in which the engine is driven by the electric motor and the metal powder is supplied to a combustion chamber of the engine by the powder supply unit.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 illustrates an electrode shape forming device according to an embodiment of the disclosure;

FIG. 2 is an enlargement view of a combustion chamber and its adjacent components;

FIG. 3 is an enlargement view of an ignition plug and its adjacent components;

FIG. 4 is a flowchart illustrating an execution procedure of an electrode shape forming method according to the embodiment of the disclosure;

FIG. 5 illustrates an example of a state in which a voltage application step is being executed;

FIG. 6 illustrates an outer electrode after the electrode shape forming method is executed;

FIG. 7 illustrates part of an electrode shape forming device according to an embodiment of the disclosure;

FIGS. 8 and 9 are a flowchart illustrating an execution procedure of an electrode shape forming method executed by the electrode shape forming device illustrated in FIG. 7;

FIG. 10A illustrates an outer electrode and a central electrode during the execution of the electrode shape forming method illustrated in FIGS. 8 and 9; and

FIG. 10B illustrates the outer electrode and the central electrode after the execution of the electrode shape forming method illustrated in FIGS. 8 and 9.

### DETAILED DESCRIPTION

To stabilize lean burn of an engine, a gas flow, such as a tumble flow, is usually generated in a combustion chamber. However, such a gas flow in the combustion chamber may vary the arc behavior of an ignition plug in a complicated manner, which may influence the designing of the shapes of a central electrode and an outer electrode of the ignition plug.

It is thus desirable to design the shapes of electrodes of an ignition plug by taking a gas flow in a combustion chamber into account.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### Electrode Shape Forming Device

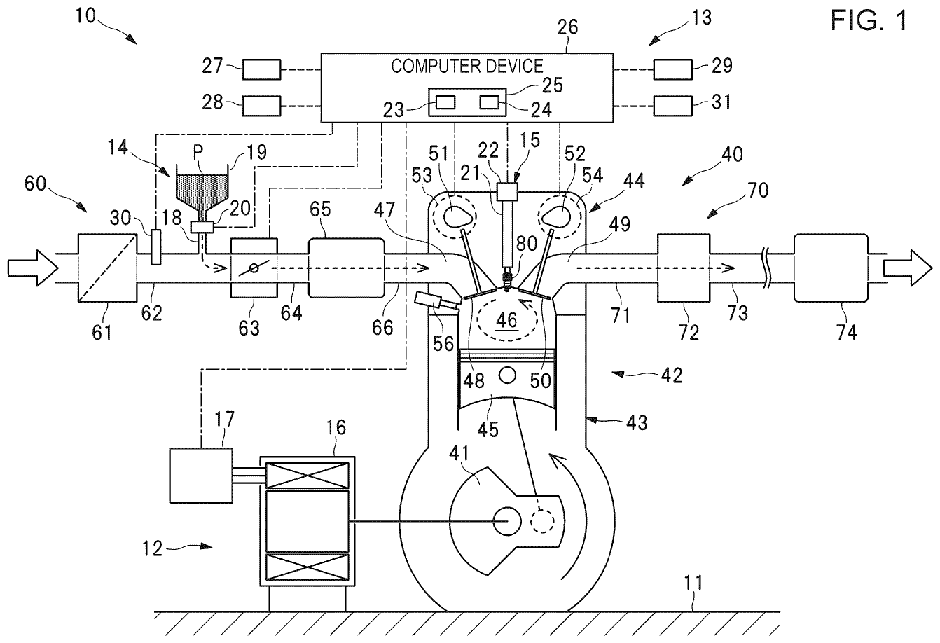

FIG. 1 illustrates an electrode shape forming device 10 according to an embodiment of the disclosure. As illustrated in FIG. 1, the electrode shape forming device 10 includes a work table 11, a motor unit 12, and a control system 13. An engine 40 is placed on the work table 11. The motor unit 12 is coupled to a crankshaft 41 of the engine 40. The control system 13 controls the engine 40 and the motor unit 12. The electrode shape forming device 10 also includes a powder supply unit 14 and a voltage application unit 15. The powder supply unit 14 is attached to an air intake system 60 of the engine 40. The voltage application unit 15 is electrically coupled to an ignition plug 80 of the engine 40. The specifications of the engine 40 are equivalent to those of a mass-produced engine loaded in a vehicle, such as an automobile. That is, the engine 40 includes an engine body 42 whose specifications are equivalent to those of the body of a mass-produced engine. The engine 40 also includes an air intake system 60 equivalent to that of a mass-produced engine and an exhaust system 70 equivalent to that of a mass-produced engine.

The motor unit 12 includes an electric motor 16 and a motor drive circuit 17. The electric motor 16 is coupled to the crankshaft (output shaft) 41. The motor drive circuit 17 controls the power status of the electric motor 16. The powder supply unit 14 includes a powder tank 19 and a flowrate control valve 20. The powder tank 19 is coupled to the air intake system 60 via a branch pipe 18. The flowrate control valve 20 is disposed on the branch pipe 18. Metal powder P made of a metal material, such as an iron alloy, is stored in the powder tank 19. The voltage application unit 15 includes an ignition coil 21 and an ignitor 22.

The control system 13 includes a computer device 26 constituted by a microcontroller 25, for example. The microcontroller 25 includes a processor 23 and a main memory 24 connected to each other so as to communicate with each other. As a result of executing a predetermined control program, the computer device 26 drives the electric motor 16 to rotate the crankshaft 41 of the engine 40 and also controls a throttle valve 63 and variable valve mechanisms 53 and 54, which will be discussed later. A motor speed sensor 27, a crank angle sensor 28, a cam angle sensor 29 are coupled to the computer device 26. The motor speed sensor 27 detects the rotational speed of the electric motor 16. The crank angle sensor 28 detects the rotation angle of the crankshaft 41 (hereinafter called the crank angle). The cam angle sensor 29 detects the rotation angle of a camshaft (hereinafter called the cam angle). The camshaft will be discussed later. An airflow sensor 30 and a throttle position sensor 31 are also coupled to the computer device 26. The airflow sensor 30 detects the flowrate of intake air. The throttle position sensor 31 detects the position of the throttle valve 63.

### Engine

As discussed above, the engine 40 includes the engine body 42. The engine body 42 is constituted by a cylinder block 43 and a cylinder head 44. A piston 45 is housed in the cylinder block 43 such that it can reciprocate therein. The crankshaft 41 is coupled to the piston 45 and is rotatably supported by the cylinder block 43. The cylinder head 44 includes an air intake port 47 and an air intake valve 48. The air intake port 47 communicates with a combustion chamber 46. The air intake valve 48 opens and closes the air intake port 47. The cylinder head 44 also includes an exhaust port 49 and an exhaust valve 50. The exhaust port 49 communicates with the combustion chamber 46. The exhaust valve 50 opens and closes the exhaust port 49. The cylinder head 44 also includes an air intake camshaft 51 and an exhaust camshaft 52. The air intake camshaft 51 drives the air intake valve 48. The exhaust camshaft 52 drives the exhaust valve 50. The cylinder head 44 also includes the variable valve mechanisms 53 and 54. The variable valve mechanism 53 controls the opening/closing timing of the air intake camshaft 51. The variable valve mechanism 54 controls the opening/closing timing of the exhaust camshaft 52.

The engine 40 includes the air intake system 60 and the exhaust system 70, as discussed above. The air intake system 60 is coupled to the air intake port 47 of the cylinder head 44. The exhaust system 70 is coupled to the exhaust port 49 of the cylinder head 44. The air intake system 60 is constituted by an air cleaner box 61, an air intake tube 62, the throttle valve 63, an air intake tube 64, a surge tank 65, and an air intake manifold 66. The above-described powder supply unit 14 is coupled to the air intake tube 62, which is positioned on the upstream side of the throttle valve 63. The exhaust system 70 is constituted by an exhaust manifold 71, a catalyst converter 72, an exhaust tube 73, and a muffler 74.

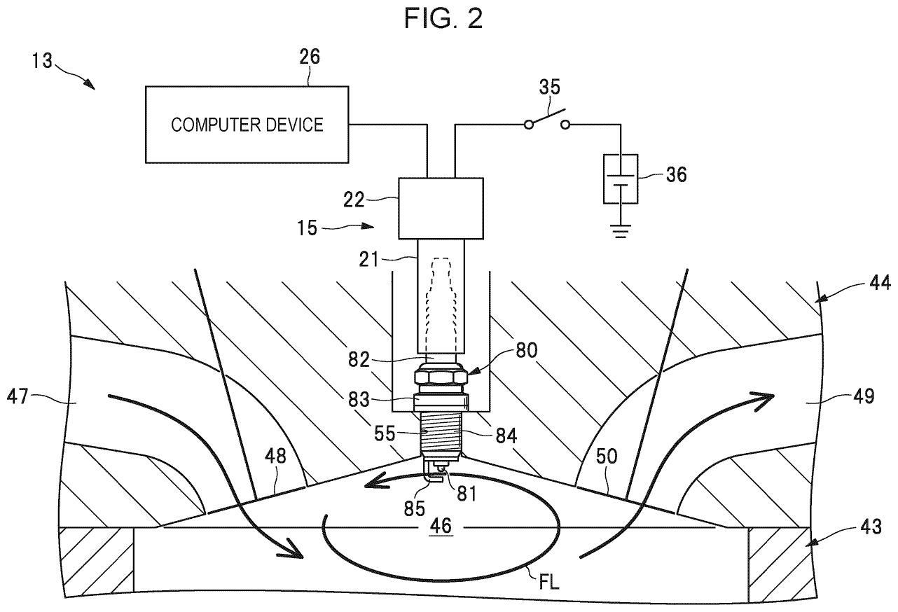

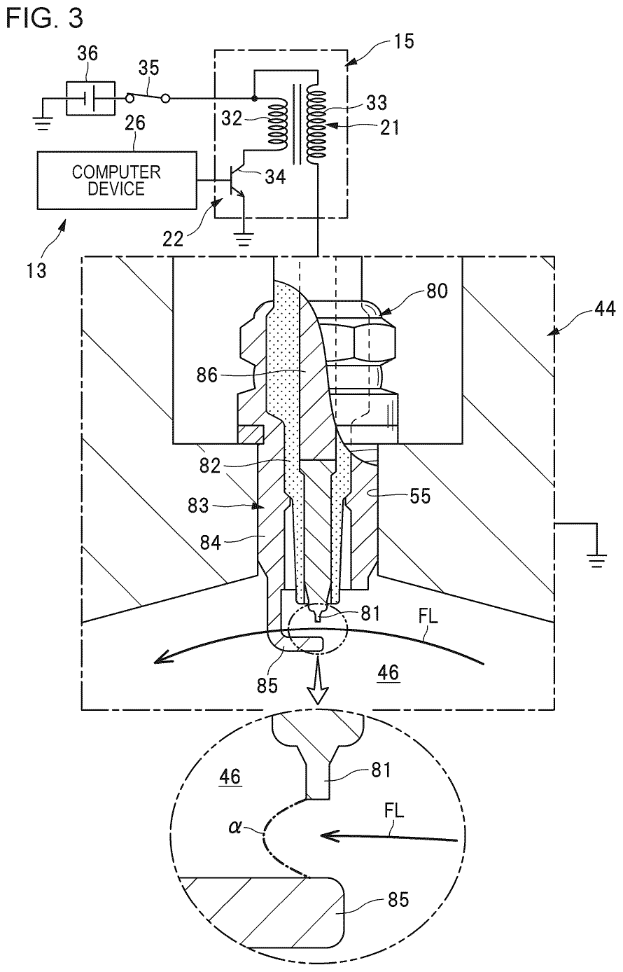

FIG. 2 is an enlargement view of the combustion chamber 46 and its adjacent components. FIG. 3 is an enlargement view of the ignition plug 80 and its adjacent components. As illustrated in FIGS. 2 and 3, the ignition plug 80 is fixed to the cylinder head 44 of the engine 40. The ignition plug 80 includes a central electrode 81 and an outer electrode 85 that are exposed to the combustion chamber 46. As illustrated in FIG. 3, the ignition plug 80 includes the central electrode 81, an insulator 82, and a housing 83. The central electrode 81 is disposed at the center of the ignition plug 80. The insulator 82 has a tubular shape and is disposed radially outward of the central electrode 81. The housing 83 has a tubular shape and is disposed radially outward of the insulator 82. The housing 83 includes a male screw 84 and the outer electrode 85. The male screw 84 is screwed into a plug hole 55 of the cylinder head 44. The outer electrode 85 is bonded to the end surface of the male screw 84. The outer electrode 85 may also be called a ground electrode.

### Voltage Application Unit

As illustrated in FIG. 3, the voltage application unit 15 includes the ignition coil 21 and the ignitor 22, as discussed above. The ignition coil 21 includes a primary coil 32 and a secondary coil 33. The ignitor 22 includes a transistor 34. One end of the primary coil 32 is coupled to a power source 36 via an ignition switch 35, while the other end of the primary coil 32 is coupled to the transistor 34 of the ignitor 22. One end of the secondary coil 33 is coupled to the power source 36 via the ignition switch 35, while the other end of the secondary coil 33 is coupled to the central electrode 81 via an electricity conducting shaft 86 of the ignition plug 80. The computer device 26 controls the transistor 34 of the ignitor 22 to turn ON and OFF a current flowing through the primary coil 32 at high speed and to apply a voltage induced in the secondary coil 33 to the central electrode 81 of the ignition plug 80. The computer device 26 generates an ignition signal indicating the ignition timing and the ON time of a current flowing through the primary coil 32, based on signals from the crank angle sensor 28, the cam angle sensor 29, and the airflow sensor 30, and sends the ignition signal to the ignitor 22. The computer device 26 can also switch the ignition switch 35 between ON and OFF.

### Gas Flow and Arc Discharge

The shapes of some components, such as the air intake port 47, the combustion chamber 46, and the piston 45, are designed to generate a gas flow FL, such as a tumble flow, in the combustion chamber 46, as illustrated in FIG. 2, in order to stabilize lean burn of the engine 40. As illustrated in FIG. 3, the gas flow FL is also generated between the central electrode 81 and the outer electrode 85, and a discharge path (hereinafter called an arc discharge path α) between the central electrode 81 and the outer electrode 85 is influenced by this gas flow FL and deviates from the shortest path therebetween. The arc discharge path α illustrated in FIG. 3 is only an example and it keeps changing in accordance with the situation of the combustion chamber 46.

### Electrode Shape Forming Method

As discussed above, the arc discharge path α of the ignition plug 80 keeps changing under the influence of the gas flow FL. It may be thus appropriate to take the gas flow FL in the combustion chamber 46 into account when designing the shapes of the central electrode 81 and the outer electrode 85 of the ignition plug 80. According to the technology of an embodiment of the disclosure, the metal powder P is thermally sprayed to the outer electrode 85 by utilizing arc discharge so as to implement the shape of the outer electrode 85 suitable for the gas flow FL in the combustion chamber 46. This will be discussed later in detail.

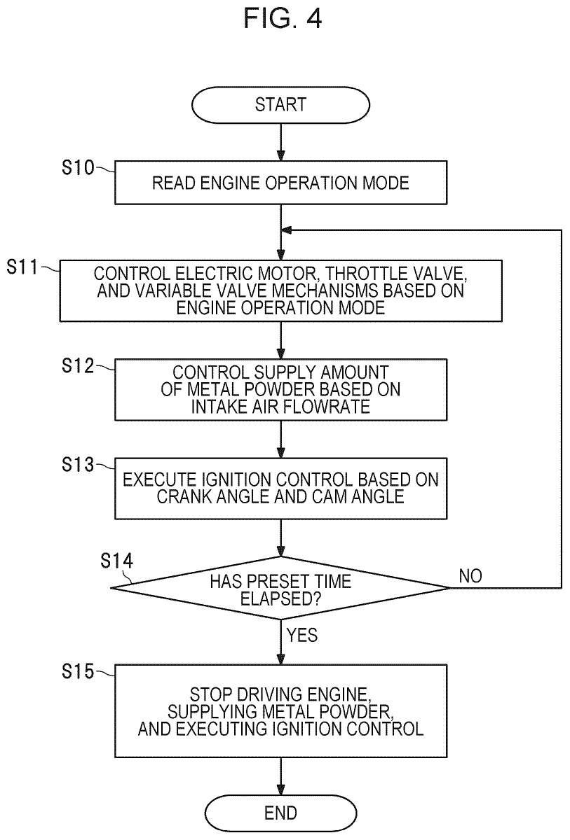

FIG. 4 is a flowchart illustrating an execution procedure of an electrode shape forming method according to an embodiment of the disclosure. Steps in the electrode shape forming method in FIG. 4 are executed by the processor 23 of the computer device 26.

As illustrated in FIG. 4, in step S10, the computer device 26 reads an engine operation mode set by an operator. The engine operation mode is a pattern of the operation of the engine 40 to be executed when the shape of the outer electrode 85 is formed. For example, the engine speed, throttle position, ignition timing, and opening/closing timing of the air intake camshaft 51 and the exhaust camshaft 52 are set in the engine operation mode.

Then, in step S11, based on the engine operation mode, the computer device 26 controls the electric motor 16 and also controls the throttle valve 63 and the variable valve mechanisms 53 and 54. This can drive the engine 40 by the electric motor 16 and also control other components, such as the throttle valve 63, so that air can flow from the air intake system 60 to the exhaust system 70 via the combustion chamber 46, similarly to the operation when driving a mass-produced engine. Driving the engine 40 by the electric motor 16 is rotating the crankshaft 41 of the engine 40 by the electric motor 16. In step S11, a fuel is not injected from an injector 56.

In step S12, the computer device 26 adjusts the flowrate control valve 20 based on the intake air flowrate so as to control the supply amount of metal powder P in relation to the intake air. As the intake air flowrate becomes greater, the computer device 26 increases the supply amount of metal powder P by opening the flowrate control valve 20. To suitably disperse the metal powder P in the intake air, the particle size of the metal powder P is regulated to several micrometers to several tens of micrometers in the embodiment.

Then, in step S13, the computer device 26 controls the voltage application unit 15 based on the crank angle and the cam angle and executes ignition control of the ignition plug 80 in accordance with the above-described engine operation mode. That is, in step S13, the voltage application unit 15 applies a breakdown voltage to the central electrode 81 so as to generate discharge (hereinafter called arc discharge) between the central electrode 81 and the outer electrode 85 of the ignition plug 80.

Then, in step S14, the computer device 26 determines whether a preset time has elapsed. If it is found in step S14 that the preset time has not elapsed, the computer device 26 returns to step S11 and maintains the operation state of the engine 40 in accordance with the engine operation mode. The computer device 26 then supplies the metal powder P in step S12 and executes ignition control in step S13. If it is found in step S14 that the preset time has elapsed, the computer device 26 proceeds to step S15 and stops driving the engine 40 and discontinues supplying the metal powder P and executing ignition control.

As stated above, in step S13 (voltage application step), arc discharge is generated between the central electrode 81 and the outer electrode 85 of the ignition plug 80 in a state in which the engine 40 is driven by the electric motor 16 and the metal powder P is supplied to the combustion chamber 46 of the engine 40.

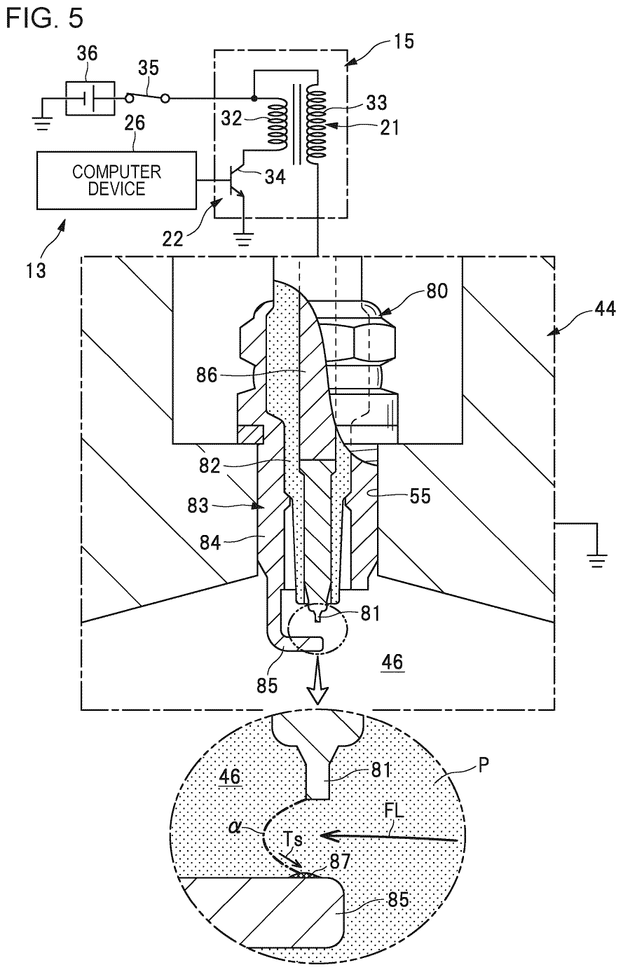

FIG. 5 illustrates an example of a state in which the voltage application step is being executed. As indicated by the enlarged portion of FIG. 5, when arc discharge is generated between the central electrode 81 and the outer electrode 85 in a state in which the metal powder P is dispersed in intake air, the intake air containing the metal powder P is ionized to become plasma and the positively charged metal powder P is thermally sprayed to the outer electrode 85, which is a negative electrode. That is, as indicated by the arrow Ts in the enlarged portion of FIG. 5, the molten metal powder P moves along the arc discharge path α and is thermally sprayed to the outer electrode 85. Then, a metal layer 87 made of the sprayed metal powder P is formed on the surface of the outer electrode 85. To reduce the influence of the initial shape of the outer electrode 85 on the arc discharge path α, the initial shape of the outer electrode 85 is desirably formed by an edgeless curved surface or flat surface.

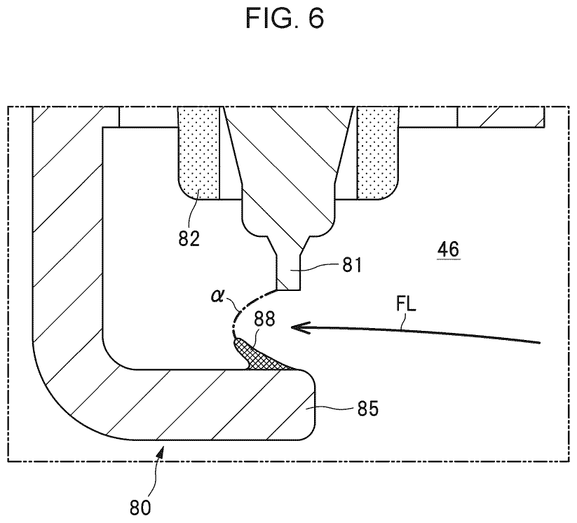

FIG. 6 illustrates the outer electrode 85 after the electrode shape forming method is executed. As discussed above, the metal powder P is thermally sprayed to the outer electrode 85 for the preset time. A multilayer member 88 extending along the arc discharge path α is thus formed on the outer electrode 85. The shape of the multilayer member 88, which is constituted by the metal layers 87, extends along the arc discharge path α, so that the shape of the outer electrode 85 suitable for the gas flow FL in the combustion chamber 46 is implemented. As discussed above, the arc discharge path α keeps changing under the influence of the gas flow FL. As a result of elongating the multilayer member 88 from the outer electrode 85 so as to follow the arc discharge path α, the outer electrode 85 having a shape suitable for the gas flow FL in the combustion chamber 46 can be formed.

The outer electrode 85 formed by the electrode shape forming method according to an embodiment of the disclosure as described above can be used as a mold for designing the electrode shape of the ignition plug 80. Additionally, the ignition plug 80 including such an outer electrode 85 formed by this electrode shape forming method can be fixed to an engine loaded in a vehicle, for example. In the above-described explanation, since the outer electrode 85 of the ignition plug 80 is a negative electrode, the shape of the outer electrode 85 is formed by thermal-spraying of the metal powder P. However, this is only an example. For instance, by setting the central electrode 81 of the ignition plug 80 to a negative electrode, the shape of the central electrode 81 may be formed by thermal-spraying of the metal powder P.

Regarding the engine operation mode to be employed when the electrode shape forming method is executed, the engine speed and the throttle position, for example, may be maintained at steady levels or they may be actively changed. For example, for an engine loaded in a hybrid vehicle, because the operating range of this engine is limited, the engine speed and the throttle position, for example, may be maintained at steady levels. In contrast, for an engine to be used in a wide operating range, the engine speed and the throttle position, for example, may be actively changed.

### Other Embodiments

In the above-described embodiment, the metal powder P is thermally sprayed to the outer electrode 85 or the central electrode 81. However, this is only an example. The metal powder P may be thermally sprayed to both of the outer electrode 85 and the central electrode 81. In the following description, an explanation will be mainly given to points different from the above-described electrode shape forming device 10 and electrode shape forming method.

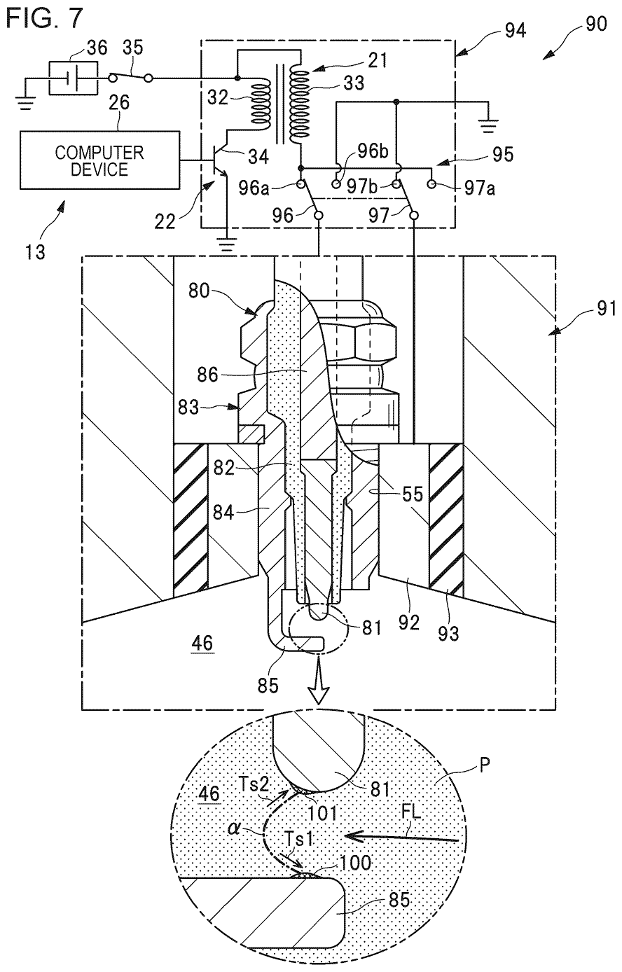

FIG. 7 illustrates part of an electrode shape forming device 90 according to another embodiment of the disclosure. As illustrated in FIG. 7, a cylinder head 91 of an engine 40 includes an electricity conducting sleeve 92 having a plug hole 55 and an insulating sleeve 93 disposed outward of the electricity conducting sleeve 92. The electricity conducting sleeve 92 is made of a metal material, while the insulating sleeve 93 is made of an insulation material.

The electrode shape forming device 90 includes a voltage application unit 94 electrically coupled to the ignition plug 80 of the engine 40. The voltage application unit 94 includes an ignition coil 21, an ignitor 22, and a switch circuit 95. The ignition coil 21 includes a primary coil 32 and a secondary coil 33. The ignitor 22 includes a transistor 34. The switch circuit 95 switches the polarity of the central electrode 81 and that of the outer electrode 85. The switch circuit 95 includes first and second positive contacts 96a and 97a coupled to the secondary coil 33 and first and second negative contacts 96b and 97b that are grounded. The switch circuit 95 also includes a central-electrode movable contact 96 and an outer-electrode movable contact 97. The central-electrode movable contact 96 is coupled to the central electrode 81 via the electricity conducting shaft 86. The outer-electrode movable contact 97 is coupled to the outer electrode 85 via the electricity conducting sleeve 92.

The switch circuit 95 can be switched between an outer-electrode ground state and a central-electrode ground state. The outer-electrode ground state is a state in which the outer electrode 85 of the ignition plug 80 is grounded. The central-electrode ground state is a state in which the central electrode 81 of the ignition plug 80 is grounded. The outer-electrode ground state of the switch circuit 95 is also a state in which the central-electrode movable contact 96 is connected to the first positive contact 96a and the outer-electrode movable contact 97 is connected to the second negative contact 97b. The central-electrode ground state of the switch circuit 95 is also a state in which the central-electrode movable contact 96 is connected to the first negative contact 96b and the outer-electrode movable contact 97 is connected to the second positive contact 97a. The switch circuit 95 is switched to one of the outer-electrode ground state and the central-electrode ground state, based on a control signal from the computer device 26.

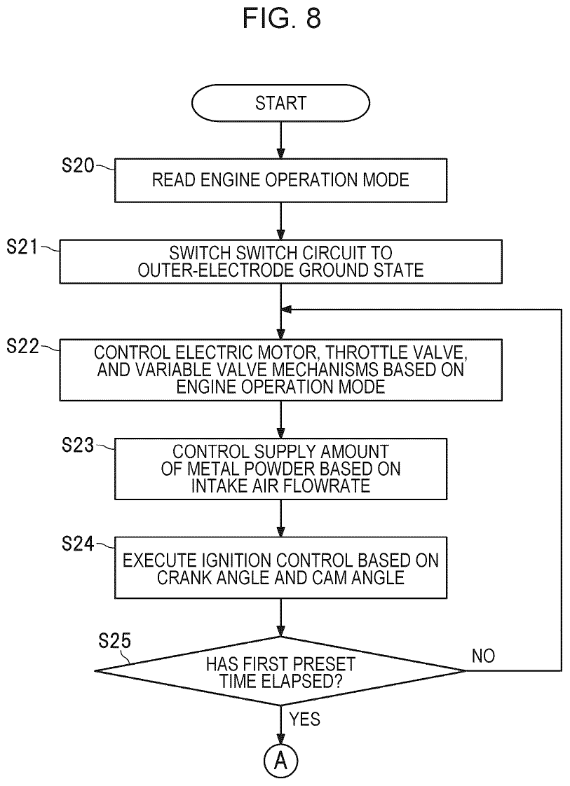

FIGS. 8 and 9 are a flowchart illustrating the execution procedure of the electrode shape forming method according to this embodiment of the disclosure. Steps in the electrode shape forming method in FIGS. 8 and 9 are executed by the processor 23 of the computer device 26.

As illustrated in FIG. 8, in step S20, the computer device 26 reads the engine operation mode set by an operator. Then, in step S21, the computer device 26 performs control to switch the switch circuit 95 to the outer-electrode ground state. With this control operation, the central electrode 81 of the ignition plug 80 is coupled to the secondary coil 33, while the outer electrode 85 of the ignition plug 80 is grounded.

Then, in step S22, based on the engine operation mode, the computer device 26 controls the electric motor 16 and also controls the throttle valve 63 and the variable valve mechanisms 53 and 54. In step S22, a fuel is not injected from the injector 56.

In step S23, the computer device 26 adjusts the flowrate control valve 20 based on the intake air flowrate so as to control the supply amount of metal powder P in relation to the intake air.

Then, in step S24, the computer device 26 controls the voltage application unit 94 based on the crank angle and the cam angle and executes ignition control of the ignition plug 80 in accordance with the engine operation mode. That is, in step S24, the voltage application unit 94 applies a breakdown voltage from the secondary coil 33 to the central electrode 81 so as to generate arc discharge between the central electrode 81 and the outer electrode 85 of the ignition plug 80. In this manner, as a result of generating arc discharge in a state in which the metal powder P is supplied to the combustion chamber 46, the metal powder P is thermally sprayed to the outer electrode 85 of the ignition plug 80.

Then, in step S25, the computer device 26 determines whether a first preset time has elapsed. If it is found in step S25 that the first preset time has not elapsed, the computer device 26 returns to step S22 and maintains the operation state of the engine 40 in accordance with the engine operation mode. The computer device 26 then supplies the metal powder P in step S23 and executes ignition control in step S24. If it is found in step S25 that the first preset time has elapsed, the computer device 26 proceeds to step S26 in FIG. 9. In step S26, the computer device 26 performs control to switch the switch circuit 95 to the central-electrode ground state. With this control operation, the central electrode 81 of the ignition plug 80 is grounded, while the outer electrode 85 of the ignition plug 80 is coupled to the secondary coil 33.

Then, in step S27, based on the engine operation mode, the computer device 26 controls the electric motor 16 and also controls the throttle valve 63 and the variable valve mechanisms 53 and 54. In step S27, a fuel is not injected from the injector 56.

In step S28, the computer device 26 adjusts the flowrate control valve 20 based on the intake air flowrate so as to control the supply amount of metal powder P in relation to the intake air.

Then, in step S29, the computer device 26 controls the voltage application unit 94 based on the crank angle and the cam angle and executes ignition control of the ignition plug 80 in accordance with the engine operation mode. That is, in step S29, the voltage application unit 94 applies a breakdown voltage from the secondary coil 33 to the outer electrode 85 so as to generate arc discharge between the central electrode 81 and the outer electrode 85 of the ignition plug 80. In this manner, as a result of generating arc discharge in a state in which the metal powder P is supplied to the combustion chamber 46, the metal powder P is thermally sprayed to the central electrode 81 of the ignition plug 80.

Then, in step S30, the computer device 26 determines whether a second preset time has elapsed. If it is found in step S30 that the second preset time has not elapsed, the computer device 26 returns to step S27 and maintains the operation state of the engine 40 in accordance with the engine operation mode. The computer device 26 then supplies the metal powder P in step S28 and executes ignition control in step S29. If it is found in step S30 that the second preset time has elapsed, the computer device 26 proceeds to step S31 and stops driving the engine 40 and discontinues supplying the metal powder P and executing ignition control.

As stated above, in step S24 (voltage application step (first step)), arc discharge is generated between the central electrode 81 and the outer electrode 85 of the ignition plug 80 in a state in which the engine 40 is driven by the electric motor 16 and the metal powder P is supplied to the combustion chamber 46 of the engine 40.

As indicated by the enlarged portion of FIG. 7, when arc discharge is generated between the central electrode 81 and the outer electrode 85 in a state in which the metal powder P is dispersed in intake air, the intake air containing the metal powder P is ionized to become plasma and the positively charged metal powder P is thermally sprayed to the outer electrode 85, which is a negative electrode.

That is, as indicated by the arrow Ts1 in the enlarged portion of FIG. 7, the molten metal powder P moves along the arc discharge path α and is thermally sprayed to the outer electrode 85. Then, a metal layer 100 made of the sprayed metal powder P is formed on the surface of the outer electrode 85. To reduce the influence of the initial shape of the outer electrode 85 on the arc discharge path α, the initial shape of the outer electrode 85 is desirably formed by an edgeless curved surface or flat surface.

In step S29 (voltage application step (second step)), arc discharge is generated between the central electrode 81 and the outer electrode 85 of the ignition plug 80 in a state in which the engine 40 is driven by the electric motor 16 and the metal powder P is supplied to the combustion chamber 46 of the engine 40.

As indicated by the enlarged portion of FIG. 7, when arc discharge is generated between the central electrode 81 and the outer electrode 85 in a state in which the metal powder P is dispersed in intake air, the intake air containing the metal powder P is ionized to become plasma and the positively charged metal powder P is thermally sprayed to the central electrode 81, which is a negative electrode.

That is, as indicated by the arrow Ts2 in the enlarged portion of FIG. 7, the molten metal powder P moves along the arc discharge path α and is thermally sprayed to the central electrode 81. Then, a metal layer 101 made of the sprayed metal powder P is formed on the surface of the central electrode 81. To reduce the influence of the initial shape of the central electrode 81 on the arc discharge path α, the initial shape of the central electrode 81 is desirably formed by an edgeless curved surface or flat surface.

As described above, the voltage application step includes the first step S24 in which the metal powder P is thermally sprayed to the outer electrode 85, which is one of the central electrode 81 and the outer electrode 85, as a result of generating discharge between the central electrode 81 and the outer electrode 85. The voltage application step also includes the second step S29 in which the metal powder P is thermally sprayed to the central electrode 81, which is the other one of the central electrode 81 and the outer electrode 85, as a result of switching the polarity of the central electrode 81 and that of the outer electrode 85 and generating discharge between the central electrode 81 and the outer electrode 85. According to the electrode shape forming method discussed with reference to FIGS. 8 and 9, after the metal powder P is thermally sprayed to the outer electrode 85, it is thermally sprayed to the central electrode 81.

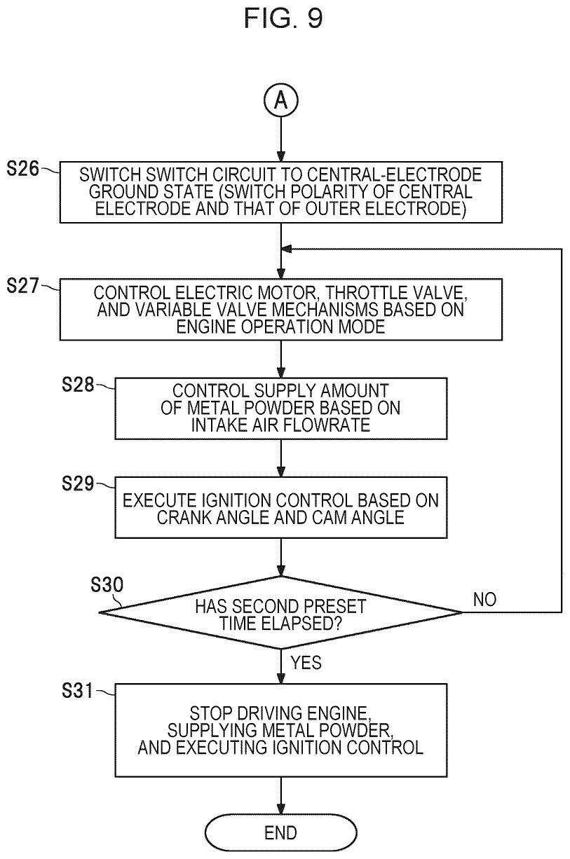

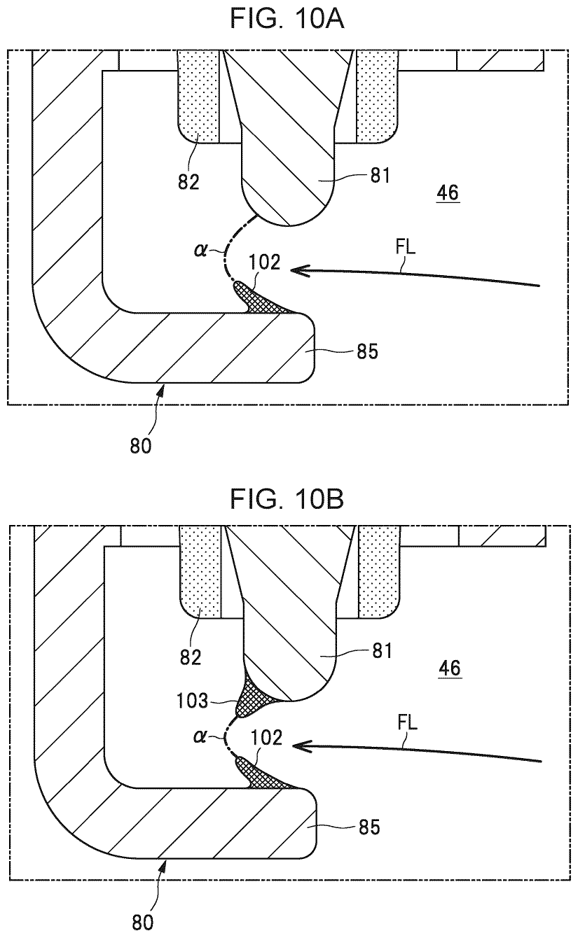

FIG. 10A illustrates the outer electrode 85 and the central electrode 81 during the execution of the electrode shape forming method. FIG. 10B illustrates the outer electrode 85 and the central electrode 81 after the execution of the electrode shape forming method.

As discussed above, the metal powder P is thermally sprayed to the outer electrode 85 for the first preset time. A multilayer member 102 extending along the arc discharge path α is thus formed on the outer electrode 85, as illustrated in FIG. 10A. The shape of the multilayer member 102, which is constituted by the metal layers 100, extends along the arc discharge path α, so that the shape of the outer electrode 85 suitable for the gas flow FL in the combustion chamber 46 is implemented. As discussed above, the arc discharge path α keeps changing under the influence of the gas flow FL. As a result of elongating the multilayer member 102 from the outer electrode 85 so as to follow the arc discharge path α, the shape of the outer electrode 85 suitable for the gas flow FL in the combustion chamber 46 can be formed.

As discussed above, the metal powder P is thermally sprayed to the central electrode 81 for the second preset time. A multilayer member 103 extending along the arc discharge path α is thus formed on the central electrode 81, as illustrated in FIG. 10B. The shape of the multilayer member 103, which is constituted by the metal layers 101, extends along the arc discharge path α, so that the shape of the central electrode 81 suitable for the gas flow FL in the combustion chamber 46 is implemented. As discussed above, the arc discharge path α keeps changing under the influence of the gas flow FL. As a result of elongating the multilayer member 103 from the central electrode 81 so as to follow the arc discharge path α, the shape of the central electrode 81 suitable for the gas flow FL in the combustion chamber 46 can be formed.

The outer electrode 85 and the central electrode 81 formed by the electrode shape forming method according to an embodiment of the disclosure as described above can be used as a mold for designing the electrode shape of the ignition plug 80. Additionally, the ignition plug 80 including such an outer electrode 85 and such a central electrode 81 formed by this electrode shape forming method can be fixed to an engine loaded in a vehicle, for example.

### Modified Examples

The disclosure is not limited to the above-described embodiments and may be modified and changed variously without departing from the technical scope of the disclosure.

In one example, in the above-described embodiments, the metal powder P made of an iron alloy is used, but metal powder made of another material may be used. For example, metal powder made of another type of alloy, such as a copper alloy, a nickel alloy, an iridium alloy, and a platinum alloy, may be used.

In another example, in the above-described embodiments, the particle size of the metal powder P is regulated to several micrometers to several tens of micrometers. However, the particle size is not limited to this range. For example, the particle size of the metal powder P may be smaller than several micrometers or may be larger than several tens of micrometers.

In the above-described embodiments, air is taken into the combustion chamber 46, but another gas, for example, an inert gas, such as an argon gas, may be taken into the combustion chamber 46.

In the flowchart in FIGS. 8 and 9, after the shape of the outer electrode 85 is formed, the shape of the central electrode 81 is formed. However, the order of forming the shape of the outer electrode 85 and that of the central electrode 81 is not limited to this order. For example, the shape of the central electrode 81 may first be formed, and then, the shape of the outer electrode 85 may be formed. The formation of the shape of the central electrode 81 and that of the outer electrode 85 may be alternately repeated.

In the flowcharts in FIGS. 4, 8, and 9, the driving of the engine 40 is started, and then, after the supply of the metal powder P is started, ignition control of the ignition plug 80 is executed. However, the order of these operations is not limited to this order. In one example, after ignition control of the ignition plug 80 is started, the supply of the metal powder P may be started. In another example, after the supply of the metal powder P is started, the driving of the engine 40 may be started.

In the example in FIG. 1, the powder supply unit 14 is coupled to the air intake tube 62, which is positioned on the upstream side of the throttle valve 63. The component that receives the powder supply unit 14 is not limited to the air intake tube 62. For example, the powder supply unit 14 may be coupled to the surge tank 65 or to the air intake port 47. The air intake system 60 and the exhaust system 70 illustrated in FIG. 1 are only examples and they may be configured in a different manner. The engine 40 may be a multicylinder engine or a single-cylinder engine.

According to an embodiment of the disclosure, metal powder is thermally sprayed to one or both of a central electrode and an outer electrode in a state in which an engine is driven by an electric motor. This makes it possible to form the electrode shape suitable for a gas flow in a combustion chamber.

The computer device 26 illustrated in FIG. 1 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the computer device 26 including the microcontroller 25, the processor 23, and the main memory 24. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 1.

1. An electrode shape forming method comprising:
generating discharge between a central electrode and an outer electrode of an ignition plug of an engine in a state in which the engine is driven by an electric motor and metal powder is supplied to a combustion chamber of the engine,
wherein, as a result of the generating the discharge between the central electrode and the outer electrode of the ignition plug, the metal powder is thermally sprayed to one or both of the central electrode and the outer electrode.

2. The electrode shape forming method according to claim 1, wherein the generating the discharge comprises:
thermally spraying the metal powder to one of the central electrode and the outer electrode as a result of generating discharge between the central electrode and the outer electrode; and
thermally spraying the metal powder to another one of the central electrode and the outer electrode as a result of switching a polarity of the central electrode and a polarity of the outer electrode and generating the discharge between the central electrode and the outer electrode.

3. The electrode shape forming method according to claim 1, wherein the metal powder is supplied from an air intake system of the engine to the combustion chamber.

4. An electrode shape forming device comprising:
an electric motor coupled to an output shaft of an engine;
a powder supply unit that is attached to the engine and stores metal powder therein; and
a voltage application unit that is coupled to an ignition plug of the engine and is configured to generate discharge between a central electrode and an outer electrode of the ignition plug,
wherein the voltage application unit is configured to thermally spray the metal powder to one or both of the central electrode and the outer electrode as a result of generating the discharge between the central electrode and the outer electrode in a state in which the engine is driven by the electric motor and the metal powder is supplied to a combustion chamber of the engine by the powder supply unit.

5. The electrode shape forming device according to claim 4, wherein the voltage application unit comprises a switch circuit configured to switch a polarity of the central electrode and a polarity of the outer electrode.

6. An electrode shape forming device comprising:
an electric motor coupled to an output shaft of an engine;
a powder supply unit that is attached to the engine and stores metal powder therein;
a voltage application unit that is coupled to an ignition plug of the engine; and
circuitry configured to
generate discharge between a central electrode and an outer electrode of the ignition plug, and
thermally spray the metal powder to one or both of the central electrode and the outer electrode as a result of generating the discharge between the central electrode and the outer electrode in a state in which the engine is driven by the electric motor and the metal powder is supplied to a combustion chamber of the engine by the powder supply unit.
